(19) United States
(12) Patent Application Publication
(10) Pub. No.: US 2022/0318131 A1
(43) Pub. Date: Oct. 6, 2022

(54) DEVICE AND METHOD FOR ASCERTAINING ADDRESS VALUES

(71) Applicant: Robert Bosch GmbH, Stuttgart (DE)

(72) Inventors: Nico Bannow, Stuttgart (DE); Jens Froemmer, Stuttgart (DE); Axel Aue, Korntal-Muenchingen (DE)

(21) Appl. No.: 17/696,135

(22) Filed: Mar. 16, 2022

(30) Foreign Application Priority Data
Mar. 30, 2021 (DE) 10 2021 203 225.7

(51) Int. Cl. G06F 12/02; G06F 9/30

(52) U.S. Cl. CPC G06F 12/023; G06F 9/3001; G06F 2212/251

(57) ABSTRACT

A device for ascertaining address values, for example, for an access to a memory unit. The device including an input value memory for the at least temporary storing of at least two input values. The device is designed to ascertain at least temporarily at least one address value based on the at least two input values.

### FIELD

The present invention relates to a device for ascertaining address values.

The present invention further relates to a method for ascertaining address values.

### SUMMARY

Exemplary specific embodiments of the present invention relate to a device for ascertaining address values, for example, for an access to a memory unit, the device including an input value memory for the at least temporary storing of at least two input values, the device being designed to ascertain at least temporarily at least one address value based on the at least two input values.

In further exemplary specific embodiments of the present invention, the device is also usable for ascertaining values other than the aforementioned address values.

In further exemplary specific embodiments of the present invention, it is provided that the device includes at least one input interface for receiving at least one first input value or the at least two input values, for example, from a further, for example, external unit.

In further exemplary specific embodiments of the present invention, it is provided that the device includes at least one address value ascertainment unit, which is designed to ascertain the address value.

In further exemplary specific embodiments of the present invention, it is provided that the device includes at least one output interface for outputting the at least one address value. The address value is useable, for example, by a further unit for the purpose of selecting or specifying a memory address in an address space of a memory unit, for example, in order to write data to the memory address and/or in order to read data from the memory address.

In further exemplary specific embodiments of the present invention, it is provided that the device is designed to ascertain at least temporarily at least one new input value, for example, based on at least one first input value of the at least two input values, or based on the at least two input values and, optionally, to overwrite at least one input value stored in the input value memory with the new input value.

In further exemplary specific embodiments of the present invention, it is provided that the device includes at least one input value ascertainment unit, which is designed to ascertain at least temporarily at least one or the at least one new input value, for example, based on at least one first input value of the at least two input values or based on the at least two input values.

In further exemplary specific embodiments of the present invention, it is provided that the device is designed to evaluate at least temporarily a) at least one first input value of the at least two input values or b) the at last two input values, an evaluation result being obtained, and to influence at least temporarily, based on the evaluation result, at least one of the following elements: a) the ascertaining of the at least one address value, b) the at least one address value, c) address value ascertainment unit, d) the ascertaining of the new input value, e) the overwriting of the at least one input value stored in the input value memory with the new input value.

In further exemplary specific embodiments of the present invention, it is provided that the device includes at least one evaluation unit, which is designed to evaluate at least temporarily a) at least one first input value of the at least two input values or b) the at least two input values, an evaluation result being obtained, and to influence at least temporarily, based on the evaluation result, at least one of the following elements: a) the ascertaining of the at least one address value, b) the at least one address value, c) address value ascertainment unit, d) the ascertaining of the new input value, e) the overwriting of the at least one input value stored in the input value memory with the new input value.

In further exemplary specific embodiments of the present invention, it is provided that the device includes at least one configuration unit, which is designed to influence and/or to change at least temporarily a configuration of at least one of the following elements: a) device, b) input value memory, c) address value ascertainment unit, d) input value ascertainment unit, e) evaluation unit, f) input interface, g) output interface, the changing being carried out, for example, at least temporarily based on at least one static configuration parameter and/or based on at least one dynamic configuration parameter.

In further exemplary specific embodiments of the present invention, it is provided that the device is designed to ascertain at least temporarily address values according to one first, for example, linear, addressing mode, for example, beginning with a start index, for example, with a constant offset, by increasing the address value uniformly by the offset, i.e., linearly, until an end index is achieved.

In further exemplary specific embodiments of the present invention, it is provided that the device is designed to ascertain at least temporarily address values according to one first, for example, non-linear addressing mode, for example, beginning with a start value, by increasing this address value non-linearly, for example, by continuous multiplication by 2 or by shifting left by 1, for example, until an end index is achieved and/or after a fixed number of generated address values is carried out.

In further exemplary specific embodiments of the present invention, it is provided that the device is designed to ascertain at least temporarily address values according to one first, for example, complex addressing mode and to ascertain at least temporarily address values according to one second, for example, complex addressing mode.

In further exemplary specific embodiments of the present invention, it is provided that the device is designed for ascertaining or generating and/or combining a plurality of linearly or non-linearly changing address values.

In further exemplary specific embodiments of the present invention, one complex addressing mode includes the ascertainment or generation and combination of a plurality of linearly or non-linearly changing address values which, for example, as a result of the combination change at least temporarily non-linearly, for example, or which change at least temporarily linearly and at least temporarily non-linearly.

In further exemplary specific embodiments of the present invention, it is provided that the device is designed to ascertain at least temporarily one first address value used as an offset according to one first addressing mode, so that this offset does not remain constant, in particular, and to ascertain at least temporarily second address values according to one second addressing mode, so that the offset as the first address value is at least temporarily combined with the second address value, for example, by continuous addition, so that a non-linear behavior is achieved in the interaction of the two addressing modes.

In further exemplary specific embodiments of the present invention, it is provided that the device is designed to ascertain at least temporarily one first address value used as an offset according to one first addressing mode, so that this offset changes, in particular, linearly, and to ascertain at least temporarily second address values according to one second addressing mode, so that the offset as the second address value is combined at least temporarily with the first address value, for example, by continuous shifting to the left, so that a non-linear behavior is achieved in the interaction of the two addressing modes.

In further exemplary specific embodiments of the present invention, complex access patterns to a memory unit, for example, may be implemented with the aid of at least one complex addressing mode, as it is implementable or usable at least temporarily by the device, which are characterizable by linearly or non-linearly changing start indices, end indices and offsets (for example, for each of the ascertained or generated address values), for example, during a single or repeated pass-through of the same dimension of a multi-dimensional field, for example, using similar or different address values in each case.

In further exemplary specific embodiments of the present invention, “complex access patterns” are understood to mean a concatenation of indices and/or offsets of various dimensions and/or a modification of indices and/or offsets (for example, in terms of input values) by indices and/or by offsets of the same and/or of other dimensions and/or, for example, by constants.

In further exemplary specific embodiments of the present invention, exemplary access patterns also include the change in indices and/or offset(s) as a function, for example, of comparisons. In further exemplary specific embodiments, indices and/or offsets and/or constants, in particular, may be integrated into these comparisons. In further exemplary embodiments, data incorporated from outside the device (for example, in the form of at least one input value) may also be incorporated into the comparisons.

In further exemplary embodiments of the present invention, it is provided that the device is designed to ascertain at least temporarily address values according to one first, for example linear, addressing mode and to ascertain at least temporarily address values according to one second, for example linear, addressing mode which, for example, is different from the first linear addressing mode.

In further exemplary specific embodiments of the present invention, it is provided that the device is designed to combine these at least two “linear” address values of the at least two linear addressing modes with one another to form a further complex addressing mode, for example, in such a way that a further complex, non-linear address value, in particular, is ascertained.

In further exemplary specific embodiments of the present invention, the device is designed to carry out a, for example, direct address computation of address values, for example, for loading/memory units in hardware (i.e., for example, completely in hardware without the use of a computer program or, generally, software or firmware), for example, in a configurable manner (for example, with the aid of the configuration unit).

In further exemplary specific embodiments of the present invention, this allows, for example, for the provision of a processing unit (for example, microcontroller, accelerator hardware for evaluating or computing, for example (deep) artificial neural networks), which is able to execute a predefinable algorithm, for example, in real time, and which is able to provide, for example, using the device according to the specific embodiments, address values, for example, according to complex access patterns to a memory for accesses to the memory, for example, also in real time. In further exemplary specific embodiments, this ensures that the processing unit obtains or is able to write sufficiently quickly, for example, in real time, i.e., for example, at a speed comparable to that at which the processing unit processes the algorithm, for example, data usable for executing the algorithm, which are read from the memory and/or written into the memory, for example, according to the complex access patterns.

In other words, it is possible in further exemplary specific embodiments of the present invention to also calculate directly, i.e., natively, complex access patterns to the memory with the aid of the device at a point in time of the execution of an algorithm.

In further exemplary specific embodiments of the present invention, the device is designed to generate a new address value per clock of a clock signal.

In further exemplary specific embodiments of the present invention, the device according to the specific embodiments may, for example, also be part of at least one loading/memory unit, i.e., for example, situated within the loading/memory unit or may be situated on the same (semiconductor) substrate as the loading/memory unit.

In further exemplary specific embodiments of the present invention, the device according to the specific embodiments may also be located outside the loading/memory unit, but, for example, interact integrally with the loading/memory unit.

In further exemplary specific embodiments of the present invention, the device is designed to avoid redundant partial computations, but to compute, for example, individual address values per loading/memory unit. This is made possible in further exemplary specific embodiments, for example, by a hierarchical structure and/or coupling of components of the device.

In further exemplary specific embodiments of the present invention, the device is designed to carry out partial computations, which may be used, for example, by multiple individual address value computations per loading/memory unit, as a result of which, for example, redundant partial computations in the multiple individual address value computations per loading/memory unit are avoidable. This is made possible in further exemplary specific embodiments, for example, by a hierarchical structure and/or coupling of components of the device.

In further exemplary specific embodiments of the present invention, the device is designed to carry out a plurality of different complex address computations (ascertainment of address values according to complex addressing modes) in a flexible, for example, freely configurable manner.

In further exemplary specific embodiments of the present invention, the device is, for example flexibly, scalable. In further exemplary specific embodiments, the device may be provided, for example, in a hardware accelerator, for example, for evaluating neural networks, for example, a specific implementation, for example, parameterization, of the hardware architecture of the device being establishable, for example, in terms of at least one of the following elements: a) selected hardware measures (for example, number and bit width of the input values, number and bit width of input value interfaces, number and bit width of output value interfaces, possibilities for evaluating the input values, possibilities for ascertaining the evaluation results, possibilities for ascertaining the address values, possibilities for ascertaining new input values, possibilities for overwriting the input values stored in the input value memories with new input values, number and specific forms in each case of individual combinable units for address value ascertainment, etc.), b) configurability (for example, using at least one of the aspects or specific embodiments cited by way of example above, i.e., for example, specifically settable per computation or algorithm), c) possible access patterns to memories, i.e., for example, possible patterns for the address value ascertainment, d) resulting installation space, for example area, of an implementation of the device or of a combination of the device with the target system, for example, with the hardware accelerator.

In further exemplary specific embodiments of the present invention, it is establishable with the aid of a parameterization of a specific hardware architecture which possibilities of the address value formation (“addressing possibilities”) are set in a static, for example hardwired, manner, for example, including the optionally available dynamic setting possibilities during the run time of the device.

In further exemplary specific embodiments of the present invention, unchangeable, non-configurable, i.e., for example, hardwired hardware structures are referred to as a “static configuration.” In further exemplary specific embodiments, static configuration parameters establish a specific static configuration of the device.

In further exemplary specific embodiments of the present invention, adjustable hardware structures, i.e., configurable or reconfigurable during the run time, for example, not hardwired, which are at least temporarily specifically set/configured, for example, are referred to as a “dynamic configuration.”

In further exemplary specific embodiments of the present invention, static configuration parameters establish a scope/the possibilities of a dynamic configuration, for example, during the run time.

In further exemplary specific embodiments of the present invention, a dynamic configuration, which is not reconfigured for the duration of a partial computation of an algorithm or of the entire algorithm, is referred to as a quasi-static configuration.

In further exemplary specific embodiments of the present invention, the computation or the ascertainment of an address value according to the specific embodiments includes the computation of addresses, sub-addresses, indices as well as further access types, via which individual data may be selected from a number of data (for example, stored in a memory unit). These are referred to below according to further exemplary specific embodiments uniformly as an address value.

In further exemplary specific embodiments of the present invention, it is provided that at least one component of the device is designed to carry out at least temporarily at least one of the following operations: a) addition, b) subtraction, c) arithmetic and/or logical shifting, d) multiplication, e) using or evaluating at least one lookup table, for example, a conversion table, f) butterfly, g) inverse increment, h) comparisons of numerical values, for example, comparisons with respect to zero, for example, greater than zero and/or smaller than zero and/or greater than or equal to zero and/or smaller than or equal to zero, and/or comparisons with respect to values not equal to zero, i) at least one combination from the above-listed operations a), b), c), d), e), f), g), h), variables and/or constants being usable, for example, as input values for at least some of the operations a), b), c), d), e), f), g), h), i).

In further exemplary specific embodiments of the present invention, it is provided that the device is designed to invalidate at least temporarily at least one input value, for example, to declare and/or to treat as invalid, for example, if the at least one input value is invalid and, optionally, to stop at least temporarily an operation of at least one component of the device and, optionally, to continue a or the operation of the at least one stopped component of the device, for example, if the at least one input value is valid.

In further exemplary specific embodiments of the present invention, it is provided that the device is designed to invalidate at least initially, for example, after a reset of the component, for example selectively or consistently, at least one input value.

In further exemplary specific embodiments of the present invention, it is provided that the device is designed to block at least temporarily a writing of data into the input value memory and/or a writing or overwriting of input values, for example, if this input value is already valid and, optionally, to then carry out a writing or overwriting of input values, i.e., to suspend the blocking, for example, if the input value is/has been invalidated during the execution.

In further exemplary specific embodiments of the present invention, it is provided that the device is designed, for example completely, as a hardware circuit.

In further exemplary specific embodiments of the present invention, it is provided that the device is designed as an integrated circuit, and that, for example, all components of the device are situated on the same substrate.

In further exemplary specific embodiments of the present invention, multiple devices according to the specific embodiments may also be provided and, for example, may be situated on the same substrate.

In further exemplary specific embodiments of the present invention, the at least one device may, for example, also be integrated into a target system, for example, into a unit for loading and/or storing data and/or into a component for direct memory accesses (DMA) and/or into a microcontroller or another type of processing unit.

Further exemplary specific embodiments of the present invention relate to a unit for loading and/or storing data, including at least one device for ascertaining address values according to the specific embodiments, the unit being designed, for example, to utilize the device for ascertaining at least one address value, for example, for a write access and/or a read access to a memory unit. In further exemplary specific embodiments, the unit for loading and/or storing data may, for example, execute with the aid of the at least one device according to the specific embodiments, for example in real time, address values for loading operations and/or storing operations with respect to at least one memory, for example, of a digital (for example, relating to the storage of digital values) semiconductor memory, for example.

Further exemplary specific embodiments of the present invention refer to a system for ascertaining address values, for example, for an access to a memory unit, including at least two devices according to the specific embodiments.

Further exemplary specific embodiments of the present invention relate to a processing unit, for example a microcontroller, including at least one device for ascertaining address values according to the specific embodiments and/or at least one unit for loading and/or storing data according to the specific embodiments and/or at least one system according to the specific embodiments.

Further exemplary specific embodiments of the present invention relate to an embedded system, for example for a control unit, for example for a vehicle, for example a motor vehicle, including at least one device according to the specific embodiments.

Further exemplary specific embodiments of the present invention relate to a method for ascertaining address values, for example for an access to a memory unit, including: storing at least temporarily at least two input values in an input value memory, ascertaining at least temporarily at least one address value based on the at least two input values.

In further exemplary specific embodiments of the present invention, it is provided that the method further includes:

ascertaining a new input value, for example, based on at least one first input value of the at least two input values or based on the at least two input values and, optionally, overwriting at least one input value stored in the input value memory with the new input value.

In further exemplary specific embodiments of the present invention, it is provided that the device evaluates at least temporarily a) at least one first input value of the at least two input values or b) the at least two input values, an evaluation result being obtained, the device influencing at least temporarily, based on the evaluation result, at least one of the following elements: a) the ascertaining of the at least one address value, b) the at least one address value, c) an address value ascertainment unit, d) the ascertaining of the new input value, e) the overwriting of the at least one input value stored in the input value memory with the new input value.

Further exemplary specific embodiments of the present invention relate to a use of the device according to the specific embodiments and/or of the unit for loading and/or storing data according to the specific embodiments and/or of the system according to the specific embodiments and/or of the processing unit according to the specific embodiments and/or of the method according to the specific embodiments for at least one of the following elements: a) ascertainment of address values, for example, for an access to a memory unit, b) ascertainment of address values according to different, for example complex, addressing modes, c) supplying a unit for loading and/or storing data and/or a processing unit with address values for accesses to a memory unit, d) derivation of address values based on other address values and/or on configuration data, d) ascertaining of address values based on at least one static configuration parameter, f) ascertaining of address values based on at least one dynamic configuration parameter.

Further features, possible applications and advantages of the present invention result from the following description of exemplary embodiments of the present invention, which are represented in the figures. All features described or represented in this case, alone or in arbitrary combination, form the subject matter of the present invention, regardless of their wording or representation in the description or in the figures.

### BRIEF DESCRIPTION OF THE DRAWINGS

FIG. 1A schematically shows a simplified block diagram of a device according to exemplary specific embodiments of the present invention.

FIG. 1B schematically shows a simplified block diagram of a device according to further exemplary specific embodiments of the present invention.

FIG. 1C schematically shows a simplified block diagram of a device according to further exemplary specific embodiments of the present invention.

FIG. 2A schematically shows a simplified flowchart of methods according to further exemplary specific embodiments of the present invention.

FIG. 2B schematically shows a simplified flowchart of methods according to further exemplary specific embodiments of the present invention.

FIG. 2C schematically shows a simplified flowchart of methods according to further exemplary specific embodiments of the present invention.

FIG. 2D schematically shows a simplified flowchart of methods according to further exemplary specific embodiments of the present invention.

FIG. 2E schematically shows a simplified flowchart of methods according to further exemplary specific embodiments of the present invention.

FIG. 2F schematically shows a simplified flowchart of methods according to further exemplary specific embodiments of the present invention.

FIG. 2G schematically shows a simplified flowchart of methods according to further exemplary specific embodiments of the present invention.

FIG. 3 schematically shows a simplified block diagram according to further exemplary specific embodiments of the present invention.

FIG. 4 schematically shows a simplified block diagram according to further exemplary specific embodiments of the present invention.

FIG. 5 schematically shows a simplified block diagram according to further exemplary specific embodiments of the present invention.

FIG. 6 schematically shows a simplified block diagram according to further exemplary specific embodiments of the present invention.

FIG. 7 schematically shows a simplified block diagram according to further exemplary specific embodiments of the present invention.

FIG. 8 schematically shows a simplified block diagram according to further exemplary specific embodiments of the present invention.

FIG. 9 schematically shows a simplified flowchart according to further exemplary specific embodiments of the present invention.

FIG. 10 schematically shows a simplified flowchart according to further exemplary specific embodiments of the present invention.

FIG. 11 schematically shows a simplified flowchart according to further exemplary specific embodiments of the present invention.

FIG. 12 schematically shows a simplified flowchart according to further exemplary specific embodiments of the present invention.

FIG. 13 schematically shows a simplified diagram according to further exemplary specific embodiments of the present invention.

FIG. 14 schematically shows a simplified block diagram according to further exemplary specific embodiments of the present invention.

FIG. 15 schematically shows a simplified diagram according to further exemplary specific embodiments of the present invention.

FIG. 16 schematically shows aspects of uses according to further exemplary specific embodiments of the present invention.

### DETAILED DESCRIPTION OF EXAMPLE EMBODIMENTS

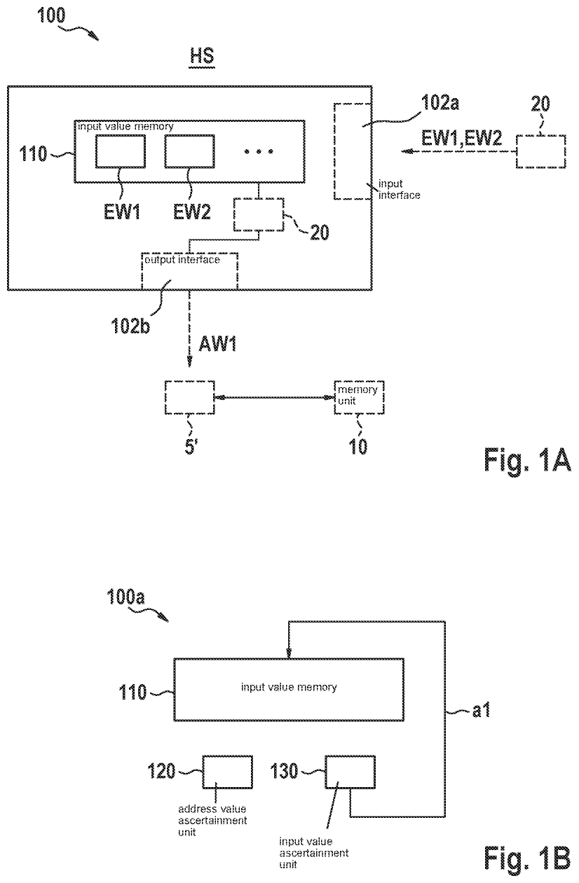

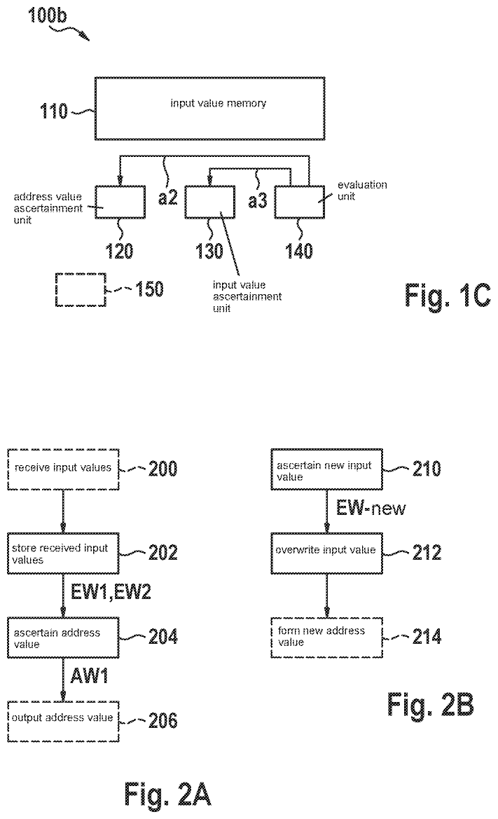

Exemplary specific embodiments, cf. FIG. 1A, relate to a device 100 for ascertaining address values, for example, for an access to a memory unit 10, device 100 including an input value memory 110 for the at least temporary storing of at least two input values EW1, EW2, device 100 being designed to ascertain at least temporarily at least one address value AW1 based on the at least two input values EW1, EW2.

In further exemplary specific embodiments, input value memory 110 includes register memories for storing input values EW1, EW2.

In further exemplary specific embodiments, it is provided that device 100 includes at least one input interface 102a for receiving at least one first input value or the at least two input values EW1, EW2, for example, from a further, for example external, unit 20.

In further exemplary specific embodiments, it is provided that device 100 includes at least one output interface 102b for outputting the at least one address value AW1. Address value AW1, which is, for example, a binary value (including multiple binary digits ‘0’, ‘1’, for example), is usable by a further unit 5′, for example, for the purpose of selecting or specifying a memory address in an address space of a or of memory unit 10, for example, in order to write data to the memory address and/or to read data from the memory address.

In further exemplary specific embodiments, see below at FIG. 1B, 1C, it is provided that device 100 includes at least one address value ascertainment unit 120, which is designed to ascertain address value AW1.

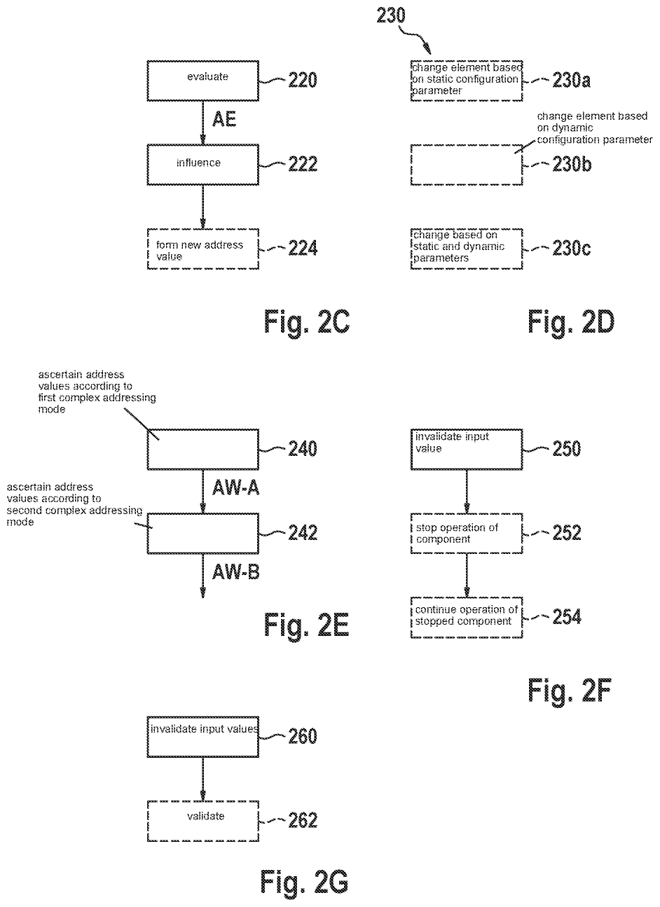

FIG. 2A schematically shows a flowchart according to further exemplary specific embodiments. In optional step 200, device 100 (FIG. 1A) receives input values EW1, EW2, for example from unit 20, in step 202, received input values EW1, EW2 are stored at least temporarily, for example, in input value memory 110, in step 204 the at least one address value AW1 is ascertained based on input values EW1, EW2, and in optional step 206, device 100 outputs the at least one address value AW1, for example to further unit 5′, which is able to use the at least one address value AW1, for example, for a reading and/or writing access to memory 10 at at least one memory address, the at least one memory address being characterizable by the at least one address value AW1.

In further exemplary specific embodiments, FIG. 2B, it is provided that device 100 is designed to ascertain 210 at least temporarily a new input value EW-new, for example, based on at least one first input value EW1 of the at least two input values EW1, EW2 or based on the at least two input values EW1, EW2 and, optionally to overwrite 212 at least one input value EW1 stored in the input value memory 110 (FIG. 1A) with new input value EW-new. In optional step 214, device 100 may then form a new address value AW1 based, for example, on at least new input value EW-new.

In further exemplary specific embodiments, FIG. 1B, it is provided that device 100a includes at least one input value ascertainment unit 130, which is designed to ascertain at least temporarily a or the new input value EW-new, for example, based on at least one first input value EW1 of the at least two input values or based on the at least two input values. The optional overwriting of an input value stored in input value memory 110 with new input value EW-new is symbolized in FIG. 1B by arrow a1.

In further exemplary specific embodiments 100b, cf. FIG. 1C and FIG. 2C, it is provided that device 100b is designed to evaluate 220 at least temporarily a) at least one first input value EW1 of the at least two input values EW1, EW2 (see also FIG. 1A) or b) the at least two input values EW1, EW2 (FIG. 2C), an evaluation result AE being obtained and, based on evaluation result AE, to influence 222 at least temporarily at least one of the following elements: a) ascertaining 204 (FIG. 2A) of the at least one address value AW1, b) the at least one address value AW1, c) address value ascertainment unit 120 (cf. arrow a2 from FIG. 1C), d) ascertaining 210 (FIG. 2B) of new input value EW-new or input value ascertainment unit 130 (cf. arrow a3 from FIG. 1C) e) overwriting 212 (FIG. 2B) of the at least one input value stored in the input value memory with new input value EW-new, see arrow a1 from FIG. 1B.

In further exemplary specific embodiments, it is provided that device 100b includes at least one evaluation unit 140, which is designed to carry out at least temporarily evaluating 220 and/or influencing 222. In optional step 224 according to FIG. 2C, device 100b may then form at least one new address value AW1 based, for example, on influencing 222.

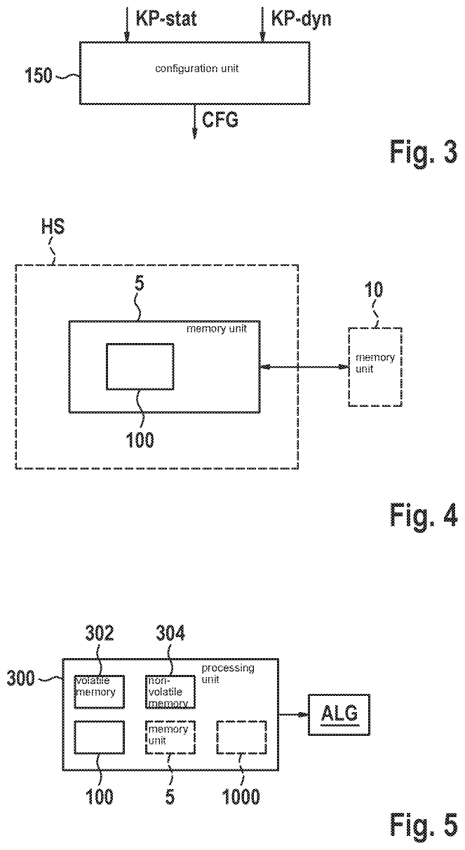

In further exemplary specific embodiments, FIG. 1C, it is provided that device 100b includes at least one configuration unit 150, which is designed to influence and/or to change 230 at least temporarily, for example dynamically, a configuration or the behavior of at least one of the following elements (FIG. 2D): a) device 100, 100a, 100b, b) input value memory 110, c) address value ascertainment unit 120, d) input value ascertainment unit 130, e) evaluation unit 140, f) input interface 102a, g) output interface 102b, h) configuration unit 150, for example, changing 230 being carried out at least temporarily based on at least one static configuration parameter, cf. step 230a according to FIG. 2D, and/or being carried out based on at least one dynamic configuration parameter, cf. step 230b. Further optional step 230c symbolizes an at least temporarily changing 230 based on at least one static configuration parameter and on at least one dynamic configuration parameter. FIG. 3 symbolizes the above-described change 230 or configuration CFG with the aid of configuration unit 150 based on at least one dynamic configuration parameter KP-dyn.

Arrow KP-stat also depicted by way of example in FIG. 3 symbolizes an optional static configuration or static configuration parameter which, in further exemplary specific embodiments, characterizes, for example, a, for example specific, hardwired form of the hardware of the device or of at least one component of the device.

In further exemplary specific embodiments, FIG. 2E, it is provided that the device is designed to ascertain 240 at least temporarily address values according to one first, for example complex, addressing mode AW-A, and to ascertain 242 at least temporarily address values according to one second, for example complex, addressing mode AW-B. In further exemplary specific embodiments, ascertainment 240, 242 may take place in temporal succession and/or at least partially temporally overlapping or simultaneously.

In further exemplary specific embodiments, a complex addressing mode AW-A, AW-B includes the ascertainment or generation of a plurality of address values, which change at last temporarily non-linearly, for example, relative to one another or with respect to successive address values, or which change at least temporarily linearly and at least temporarily non-linearly.

In further exemplary specific embodiments, for example, complex access patterns may be implemented, for example, to a memory unit 10 with the aid of at least one complex addressing mode, as it is executable or usable at least temporarily by device 100, 100a, 100b, which are characterizable, for example, by linearly and non-linearly changing address values, start indices, end indices and offsets, for example, during a single and/or repeated pass-through of the same dimension of a multi-dimensional field, for example, with similar or different address values in each case.

In further exemplary specific embodiments, “complex access patterns” are understood to mean a concatenation of address values and/or of indices and/or of offsets of various dimensions and/or a modification of address values and/or of indices and/or of offsets by address values and/or indices and/or offsets of the same and/or of other dimensions and/or by, for example, constants.

In further exemplary specific embodiments, complex access patterns include a change in address values and/or in indices and/or in offset(s) as a function, for example, of comparisons. In further exemplary specific embodiments address values and/or indices and/or offsets and/or constants, in particular, may be integrated into these comparisons. In further exemplary specific embodiments, data arriving from outside the device (for example, in the form of at least one input value EW1) may also be incorporated into the comparisons. According to further exemplary specific embodiments, the comparing may be carried out, for example, with the aid of evaluation unit 140.

In further exemplary specific embodiments, it is provided that the device is designed to ascertain at least temporarily address values according to one first, for example linear, addressing mode, for example, beginning with a start index, for example with a constant offset, by increasing the address value uniformly by the offset, i.e., linearly, until an end index is achieved.

In further exemplary specific embodiments, it is provided that the device is designed to ascertain at least temporarily address values according to one first, for example non-linear, addressing mode, for example, beginning with a start value, by increasing this address value non-linearly, for example, by continuous multiplication by 2 or by shifting left by 1, for example, until an end index is achieved and/or after a fixed number of generated address values is carried out.

In further exemplary specific embodiments, it is provided that the device is designed to ascertain at least temporarily one first address value used as an offset according to one first addressing mode, so that this offset, in particular, does not remain constant, and to ascertain at least temporarily second address values according to one second addressing mode, so that the offset as the first address value is combined at least temporarily with the second address value, for example, by continuous addition, so that a non-linear behavior is achieved in the interaction of the two addressing modes. In further exemplary specific embodiments, for example, a plurality of address values is not necessarily generated for a linear addressing.

In further exemplary specific embodiments, device 100, 100a, 100b is designed to carry out a, for example direct, address computation of address values AW1, for example, for loading/memory units 5′ (FIG. 1A), 5 (FIG. 4) in hardware (i.e., for example, completely in hardware without the use of a computer program or, generally, software or firmware), for example, in a configurable manner (for example, with the aid of configuration unit 150).

In further exemplary specific embodiments, FIG. 5, this allows, for example, for the provision of a processing unit 300 (for example, microcontroller, accelerator hardware for evaluating, for example (deep) artificial neural networks, data flow processor), which is able to execute a predefinable algorithm ALG, for example in real time, and which is able to provide, for example, using device 100 according to the specific embodiments, address values AW1, for example, according to complex access patterns to a memory 10 (FIG. 1), for accesses to memory 10, for example, also in real time. In some specific embodiments, the memory may be integrated into processing unit 300, cf., for example, volatile memory (for example, RAM, working memory) 302 depicted by way of example in FIG. 5 and/or non-volatile memory (for example Flash-EEPROM) 304 depicted by way of example in FIG. 5, in other specific embodiments, however, may also be situated outside processing unit 300, cf. element 10 of FIG. 1A.

In further exemplary specific embodiments, this ensures that processing unit 300 obtains or is able to write sufficiently quickly, for example in real time, i.e., for example, at a speed comparable to that at which processing unit 300 processes the algorithm, for example, data usable for executing algorithm ALG which, for example, are read from memory 302 and/or written into the memory according to the complex access patterns.

In other words, it is possible in further exemplary specific embodiments to also compute complex access patterns directly, i.e., natively, in memory 302 with the aid of device 100 at a point in time of the execution of an algorithm ALG.

In further exemplary specific embodiments, device 100 is designed to generate a new address value AW1 per clock of a clock signal.

In further exemplary specific embodiments, device 100 according to the specific embodiments may, for example, also be part of at least one loading/memory unit 5 (FIG. 4), i.e., for example, may be situated within the loading/memory unit or situated on the same (semiconductor) substrate HS as loading/memory unit 5.

In further exemplary specific embodiments, device 100 according to the specific embodiments may also be located outside of loading/memory unit 5, but interact integrally with the loading/memory unit.

In further exemplary specific embodiments, device 100 is designed to avoid redundant partial computations, but, to compute, for example, individual address values AW1 per loading/memory unit 5. This is made possible in further exemplary specific embodiments, for example, by a hierarchical structure and/or coupling of components of device 100, which is described in greater detail below.

In further exemplary specific embodiments, device 100 is designed to carry out partial computations, which may be used, for example, by multiple individual address value computations per loading/memory unit, as a result of which, for example, redundant partial computations in the multiple individual address value computations per loading/memory unit are avoidable. This is made possible in further exemplary specific embodiments, for example, by a hierarchical structure and/or coupling of components of device 100.

In further exemplary specific embodiments, device 100 is designed to carry out in a flexible, for example, freely configurable manner, a plurality of different complex address computations (ascertainment of address values according to complex addressing modes).

In further exemplary specific embodiments, device 100 is, for example flexibly, scalable. In further exemplary specific embodiments, device 100 may, for example, be provided in a hardware accelerator, for example, for evaluating neural networks, a specific implementation, for example, parameterization, for example, of the hardware architecture of the device being establishable, for example, in terms of at least one of the following elements: a) selected hardware measures (for example, number and bit width of input values, number and bit width of input value interfaces, number and bit width of output value interfaces, possibilities for evaluating the input values, possibilities for ascertaining the evaluation results, possibilities for ascertaining the address values, possibilities for ascertaining new input values, possibilities for overwriting input values stored in the input value memories with new input values, number and in each case specific form of individual combinable units for address value ascertainment, etc.) b) configurability (for example, using at least one of the aspects or specific embodiments cited by way of example above, i.e., for example, specifically settable per computation or algorithm), c) possible access patterns to memory, i.e. for example, possible patterns for the address value ascertainment, d) resulting installation space, for example, area, of an implementation of the device or of a combination of the device with the target system, for example, with the hardware accelerator.

In further exemplary specific embodiments, it is establishable with the aid of a parameterization of a specific hardware architecture, which possibilities of the address value formation (“addressing possibilities”) are set statically, for example, in a hardwired manner, for example, including the potentially available dynamic setting possibilities during the run time of the device.

In further exemplary specific embodiments, “dynamic configuration” refers to hardware structures settable, i.e., configurable or reconfigurable during the run time, for example, not hardwired, which are at least temporarily specifically set/configured, for example.

In further exemplary specific embodiments, static configuration parameters establish a scope/the possibilities of a dynamic configuration, for example during the run time.

In further exemplary specific embodiments, static configuration parameters KP-dyn establish a scope/the possibilities of a dynamic configuration.

In further exemplary specific embodiments, a quasi-static configuration refers to a dynamic configuration, which is not reconfigured for the duration of a partial computation of an algorithm ALG (FIG. 5) or of the entire algorithm.

In further exemplary specific embodiments, the computation or ascertainment 204 (FIG. 2A) of an address value AW1 according to the specific embodiments includes, for example, the computation of addresses, sub-addresses, indices as well as further access types, via which individual data from a number of data (for example stored in a memory unit 10, 302) may be selected. These are referred to below according to further exemplary specific embodiments uniformly as an address value.

In further exemplary specific embodiments, it is provided that at least one component 110, 120, 130, 140, 150, 102a, 102b of device 100, 100a, 100b is designed to carry out at least temporarily at least one of the following operations: a) addition, b) subtraction, c) arithmetic and/or logical shifting, d) multiplication, e) using or evaluating at least one lookup table, for example a conversion table, f) butterfly, g) inverse increment, h) comparisons with respect to zero, for example, greater than zero and/or smaller than zero and/or greater than or equal to zero and/or smaller than or equal to zero, i) at least one combination from the above-listed operations a), b), c), d), e), f), g), h), variables and/or constants being usable, for example, as input values for at least some of operations a), b), c), d), e), f), g), h), i).

In further exemplary specific embodiments, FIG. 2F, it is provided that the device is designed to invalidate 250, for example to declare and/or to treat as invalid, at least temporarily at least one input value EW1 and, optionally, to stop 252 at least temporarily an operation of at least one component 110, 120, 130, 140, 150, 102a, 102b of the device and, optionally, to continue 254 a or the operation of the at least one stopped component 110, 120, 130, 140, 150, 102a, 102b of the device.

In further exemplary specific embodiments, it is provided that device 100, 100a, 100b is designed to block at least temporarily a writing of data into input value memory 110 and/or a writing or overwriting of input values. After the blocking, an optional termination of blocking 160 may take place in further exemplary specific embodiments, for example, upon occurrence of a predefinable condition.

In further exemplary specific embodiments, it is provided that device 100, 100a, 100b is designed, for example, completely, as a hardware circuit.

In further exemplary specific embodiments, it is provided that device 100, 100a, 100b is designed as an integrated circuit, and that, for example, all components of the device are situated on one and the same substrate or semiconductor substrate HS (FIG. 1A).

In further exemplary specific embodiments, multiple devices according to the specific embodiments may also be provided and, for example, may be situated on the same substrate.

In further exemplary specific embodiments, the at least one device 100 may, for example, also be integrated into a target system 5 (FIG. 4), for example, into a unit for loading and/or storing data and/or into a component for direct memory accesses (DMA) and/or into a microcontroller 300 (FIG. 5) or another type of processing unit.

Further exemplary specific embodiments relate to a unit 5 (FIG. 4) for loading and/or storing data, including at least one device 100 for ascertaining address values according to the specific embodiments, unit 5 being designed, for example, to utilize device 10 for ascertaining at least one address value AW1, for example, for a write access and/or a read access to a memory unit 10. In further exemplary specific embodiments, unit 5 for loading and/or storing data, for example, with the aid of the at least one device 100 according to the specific embodiments may execute, for example in real time, address values for loading operations and/or storing operations with respect to at least one memory, for example, of a digital semiconductor memory.

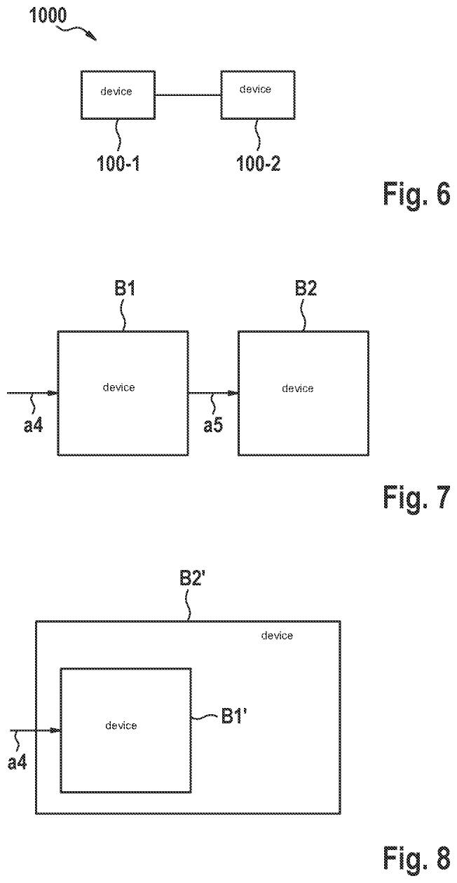

Further exemplary specific embodiments, FIG. 6, refer to a system 1000 for ascertaining address values, for example, for an access to a memory unit, including at least two devices 100-1, 100-2 according to the specific embodiments. In further exemplary specific embodiments, system 1000 may, for example, also be integrated into processing unit 300 (FIG. 5).

In further exemplary specific embodiments, the two devices 100-1, 100-2 may, for example, operate independently of one another. In further exemplary specific embodiments, the two devices 100-1, 100-2 may, for example, also cooperate, for example, in order to generate useable values as address values for an addressing.

Further exemplary specific embodiments, FIG. 5, relate to a processing unit 300, for example a microcontroller, including at least one device 100, 100a, 100b for ascertaining address values according to the specific embodiments and/or at least one unit 5, (FIG. 4) for loading and/or storing data according to the specific embodiments and/or at least one system 1000 (FIG. 6) according to the specific embodiments.

Further exemplary specific embodiments relate to an embedded system 300, for example for a control unit, for example for a vehicle, for example a motor vehicle, including at least one device 100 according to the specific embodiments.

Further exemplary specific embodiments, FIG. 2A, relate to a method for ascertaining address values, for example, for an access to a memory unit 10, including: storing 202 at least temporarily at least two input values EW1, EW2 in an input value memory 110 (FIG. 1A), ascertaining 204 at least temporarily at least one address value AW1 based on the at least two input values EW1, EW2.

In further exemplary specific embodiments, FIG. 2B, it is provided that the method further includes: ascertaining 210 a new input value EW-new, for example, based on at least one first input value of the at least two input values or based on the at least two input values and, optionally, overwriting 212 at least one input value stored in the input value memory with the new input value.

In further exemplary specific embodiments, FIG. 2C, it is provided that the device evaluates 220 at least temporarily a) at least one first input value of the at least two input values or b) the at least two input values, an evaluation result AE being obtained, the device influencing 222 at least temporarily, based on the evaluation result, at least one of the following elements: a) the ascertaining of the at least one address value, b) the at least one address value, c) an address value ascertainment unit, d) the ascertaining of the new input value, e) the overwriting of the at least one input value stored in the input value memory with the new input value.

FIG. 7 schematically shows a simplified block diagram according to further exemplary specific embodiments. Block B1 symbolizes a device 100, 100a, 100b according to the specific embodiments, as it has been described by way of example above with reference to FIG. 1. A configuration is optionally feedable to device B1, cf. arrow a4, for example, via input interface 102a (FIG. 1A). Configuration a4 in further exemplary specific embodiments may include, for example, dynamic configuration parameters. Static configuration parameters in further exemplary specific embodiments are implementable, for example, via a corresponding hardwiring. Arrow a5 according to FIG. 7 symbolizes at least one address value generated by device B1, for example, based on configuration a4, which is optionally feedable to a unit B2. Unit B2 may use address value a5, for example, as an input value, compute a unique address value based thereon, and utilize this address value for a memory access to a memory unit not depicted in FIG. 7.

FIG. 8 schematically shows a simplified block diagram according to further exemplary specific embodiments, in which device 100, cf. also block B1′, is integrated into unit B2′. Unit B2, B2′ may, for example, also be a device according to the type of device 100, B2′ being located, for example, hierarchically above B1′, B2′, for example, using address values a5 generated with the aid of device 100, B1, B1′, for example, as input values.

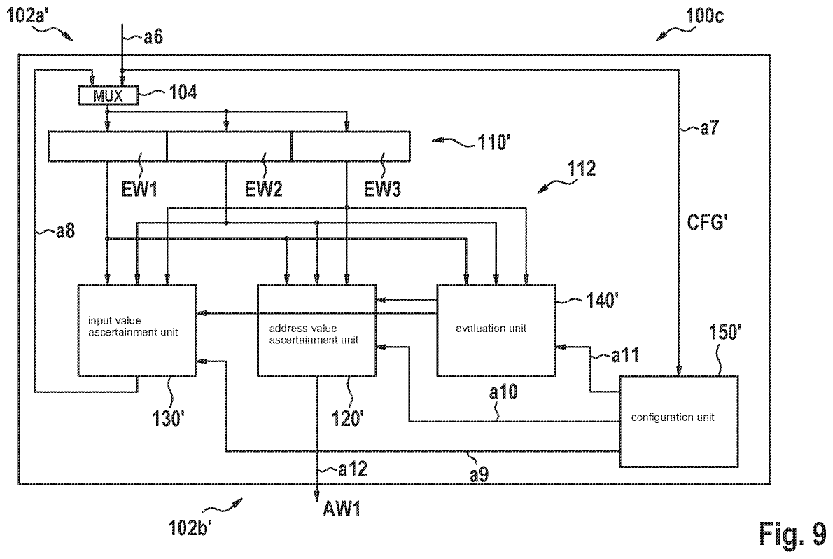

FIG. 9 schematically shows a simplified diagram of a device 100c according to further exemplary specific embodiments. Device 100c includes an input value memory 110′ (for example, three memory registers) for storing at least temporarily in the present case, by way of example, three input values EW1, EW2, EW3. Configuration data and/or input values, for example, for input value memory 110′ are feedable via input interface 102a′ to device 100c, cf. arrow a6.

In further exemplary specific embodiments, configuration data CFG′ are transferrable, for example, via a direct data link a7 from input interface 102a′ to configuration unit 150′.

In further exemplary specific embodiments, an optional multiplex unit 104 is provided, which is designed to feed data receivable via input interface 102a′, for example, input values a6, selectively as one of the in the present case, by way of example, three possible input values EW1, EW2, EW3 to input value memory 110′. Alternatively or in addition, multiplex unit 104 may also feed output data of an input value ascertainment unit 130′ to input value memory 110′, for example, new input values, for example, via a direct data link a8 between input value ascertainment unit 130′ and multiplex unit 104.

In further exemplary specific embodiments, data of input value memory 110′, for example, of one or multiple of input values EW1, EW2, EW3, are feedable, for example, via respective direct data links, which are identified in FIG. 9 collectively with reference numeral 112, to at least one of the following components: input value ascertainment unit 130′, address value ascertainment unit 120′, evaluation unit 140′.

The function of components 120′, 130′, 140′ corresponds in further exemplary specific embodiments, for example, to the corresponding function of components 120, 130, 140 described above with reference to FIG. 1.

An operation of at least one of components 120′, 130′, 140′ is configurable at least temporarily in further exemplary specific embodiments by configuration unit 150′, cf., for example, direct data links or configuration links a9, a10, a11.

In further exemplary specific embodiments, various (at least two, in FIG. 9, for example, three) input values EW1, EW2, EW3 may be combined at least temporarily for generating and outputting address values AW1 by device 100c. Input values EW1, EW2, EW3 in further exemplary specific embodiments are set, for example, by a configuration a6 dynamically taking place from the outside, for example, with the aid of configuration unit 150′, for example, by controlling a processing unit 300 (FIG. 5) or a state machine or the like.

In further exemplary specific embodiments, at least some of input values EW1, EW2, EW3 may stem from preceding computations, i.e., may be the result of preceding results of input value ascertainment unit 130′ of device 100c.

In further exemplary specific embodiments, at least some of the input values may be constants.

In further exemplary specific embodiments, a first input value EW1 may be a base address of a memory area, for example, of memory unit 10 or within memory unit 10, and a second input value EW2 may be an offset (for example, a positive differential value), for example, for selecting an element within the memory area, whose start is characterized by the base address, thus, by first input value EW1.

In further exemplary specific embodiments, the two input values EW1, EW2 may, for example, be added and the result may be output as a generated address value AW1.

In further exemplary specific embodiments, input values EW1, EW2, EW3 are combined by device 100c and as a result at least one new input value EW-new (FIG. 2B) is computed, which is usable, for example, for the purpose of overwriting an old input value in input value memory 110′. In further exemplary specific embodiments, the writing of an input value EW-new may thus take place, for example, also internally within device 100c. For example, an original offset may be overwritten as input value EW2 increased by an increment value “delta” (EW2+delta) and thus form a new offset in the form of input value EW2. Increment value “delta” may be established, for example, by a further input value EW3. Address value AW1 may, for example, be computed continuously from an addition of base address EW1 to offset EW2, for example, whenever EW2 has been updated by addition to increment EW3.

In further exemplary specific embodiments, a computation of address values or new input values EW-new is controlled by an evaluation of input values EW1, EW2, etc., cf., for example, arrows a8, a12.

In further exemplary specific embodiments, when reaching a particular value of the offset, the original start value of this offset may, for example, be restored in order to start a new pass-through. For example, the restoration of the offset of a dimension in further exemplary specific embodiments could be conditionally triggered by a progression of the next higher dimension.

In further exemplary specific embodiments, a control of the computation or ascertainment of output values of components 120′, 130′ 140′ may be set or influenced by static and/or dynamic configuration parameters (see also FIG. 3, KP-stat, KIP-dyn). For example, the behavior cited by way of example above may be set with the aid of a specification of corresponding configuration parameters.

As previously mentioned above, input values EW1, EW2, EW3 in further exemplary specific embodiments are preferably stored in registers. In this way, it is possible in further exemplary specific embodiments, to read and/or to write potentially all used registers within one clock.

In further exemplary specific embodiments, input values EW1, EW2, EW3 may be used directly and/or indirectly (for example, by a subsequent manipulation of the input values, by computing interim results, etc.).

In further exemplary specific embodiments, the input values for computing address values a12, the input values for computing at least one new input value a8 as well as the at least one newly computed input value EW-new may be the same, partially the same or different, in particular, may include the same, partially the same or different memory locations, for example, within input value memory 110′.

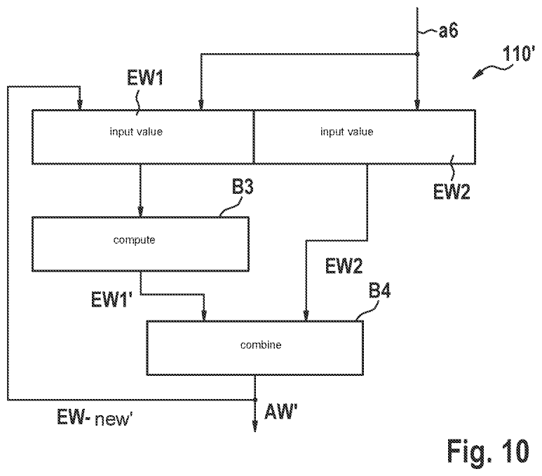

FIG. 10 schematically shows a simplified flowchart according to further exemplary specific embodiments for illustrating, for example, a subsequent manipulation of the input values that is possible in further exemplary specific embodiments, a computation of interim results as well as a use of the interim results for computing an address value AW′ (a) as well as a new input value EW-new′. Depicted are: a) two input values EW1, EW2, which may, for example, be written from outside (the device), b) first input value EW1 may optionally be recomputed (cf. block B3) and may be overwritten by the device (EW-new′), c) in the computation first input value EW1 is initially manipulated by a computation by block B3, d) indirect (manipulated) first input value EW1′ and direct second input value EW2 are combined with the aid of block B4 and in this way may result in or form address value AW′ or new input value EW-new′. Thus, first input value EW1 according to FIG. 10 is integrated in the present case indirectly and second input value EW2 is integrated directly into the computation by block B4.

In further exemplary specific embodiments, the functionality of blocks B3, B4 according to FIG. 10 may be implemented by at least one of components 120′, 130′, 140′ according to FIG. 9.

The operations referred to as combination, computation, manipulation may include in further exemplary specific embodiments, for example, addition, subtraction, arithmetic and/or logical shifting, multiplication, lookup table (conversion table), butterfly, inverse increment and other arbitrary combinatory logic. These operations may also be arbitrarily combined in further exemplary specific embodiments.

In further exemplary specific embodiments, it is advantageous to maintain the operations not statically fixed but, for example, dynamically configurable: for example, whether these are even carried out, and/or how these are carried out. In further exemplary specific embodiments, for example, it may be provided to add exactly three input values EW1, EW2, EW3 (FIG. 9) to one another in one operation. One advantageous variant according to further exemplary specific embodiments here would be to expand the addition operation to the extent that, for example, each individual one of the three input values EW1, EW2, EW3 may be set to “0” before or when entering into the addition. In this way, for example, also merely two values may be added to one another in further exemplary specific embodiments, or also merely one single value may be passed through unchanged, even if the addition is designed for up to three operands. The control of such an operation or of such a dynamic configuration is possible in further exemplary specific embodiments with the aid of configuration unit 150′.

In further exemplary specific embodiments, local (acting within the register memory) manipulations may be applied to input registers (for example, register memories of input value memory 110, 110′) which, in the further use of the register or of the input value stored therein, affect merely individual or a limited number of subsequent computations.

In further exemplary specific embodiments, global manipulations may be applied to input registers, which affect, for example every further use of the register or of the input value stored therein in subsequent computations.

In further exemplary specific embodiments, a further advantageous operation is the invalidation of input values, cf.

for example, block 260 according to FIG. 2G. An invalidation 260 in further exemplary specific embodiments may be advantageous, for example, when external sources, for example upstream processing units, compute this input value and send it to the device according to the specific embodiments.

In further exemplary specific embodiments, an advantageous synchronization with external sources is possible via the invalidation and/or a blocking as well as via the validation or continuation.

One external source (20) (FIG. 1A, 7, 8) in further exemplary specific embodiments may, for example, also include a device according to the specific embodiments. Thus, in further exemplary specific embodiments, external source 20 and device 100 may cooperate.

In further exemplary specific embodiments, it may be advantageous that, for example, as long as/if input values are invalid or have been invalidated and these are usable, for example necessary, in particular, (corresponding to configuration CFG) for a computation, the address value computation may be stopped, for example, directly, for example, temporarily. Upon receipt of an input value, this input value, for example, becomes immediately valid and—for example, if all usable or required input values are present—the computation in further exemplary specific embodiments may be continued, for example, immediately.

In further exemplary specific embodiments, input values EW1, EW2, etc. may, for example, be immediately accepted by an external source 20. In further exemplary specific embodiments, it may, however, also be advantageous if the input values are, for example, optionally unable to be accepted by an external source 20, in particular, as long as the corresponding input values are (still) valid. Invalidation 260 and validation 262 (FIG. 2G) allow in this combination in further exemplary specific embodiments for a synchronization of the computations of device 100 together with one or with multiple external sources 200, which provide input data or input values.

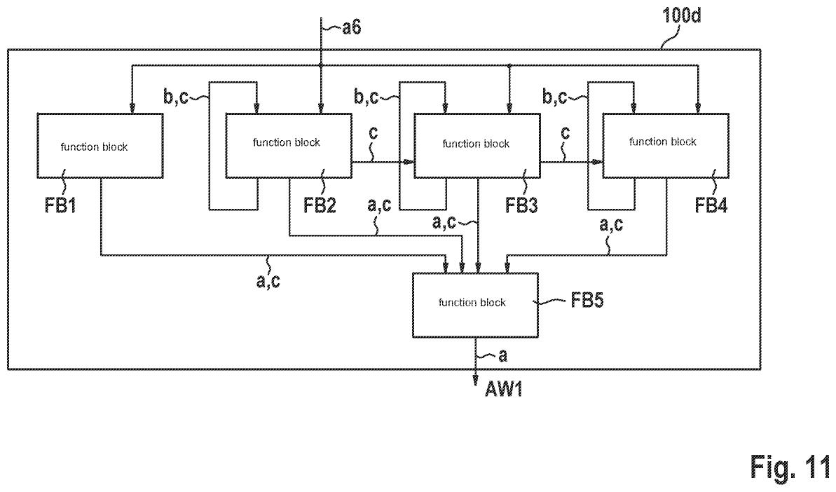

FIG. 11 schematically shows a simplified diagram according to further exemplary specific embodiments. A device 100d is depicted, which includes multiple function blocks FB1, FB2, FB3, FB4, FB5, multiple function blocks FB1, FB2, FB3, FB4, FB5, for example, each characterizing interactive instances of one or of multiple devices 100 of the type described by way of example above.

In further exemplary specific embodiments, some, for example, comparatively complex, forms of the device according to the specific embodiments are divided into substructures—referred to hereinafter as “offsets,” which are symbolized by way of example by function blocks FB1, FB2, FB3, FB4, FB5 in FIG. 11.

In further exemplary specific embodiments, the division into offsets FB1, . . . , FB5 is an optional structuring, which in further exemplary specific embodiments is optionally not to be used or is not required or is not useful.

In further exemplary specific embodiments, an offset FB1, . . . , FB5 may, for example, include in each case at least one part of a functionality of at least one of components 110′, 120′, 130′, 140′, 150′ according to FIG. 9.

In other words, it is also possible in further exemplary specific embodiments to implement the functionality described below using exemplary offsets FB1, . . . , FB5 with the configuration depicted, for example, in FIG. 1 and/or in FIG. 9.

Offsets FB1, . . . , FB5 in further exemplary specific embodiments may, for example, be designed so that they interact in such a way that in their entirety an interleaving or a hierarchy of multiple loop planes is made possible. For example, when an inner or hierarchically deeper loop is completed, an upper or hierarchically higher loop is able to proceed, while at the same time the completed loop is reset or readjusted to its new start values.

In multidimensional fields, it is thus possible in further exemplary specific embodiments to advantageously use one offset each for computing the indices of exactly one dimension. The number of offsets as well as the specific form of every offset may be established for the device in an actual instantiation in/form of the device or of the hardware circuit and in further exemplary specific embodiments may thus represent a static parameter.

The offsets actually used during the operation are settable in further exemplary specific embodiments with the aid of a dynamic configuration.

A combination of the individual offsets to form an address may be configured in further exemplary specific embodiments, for example, via static and dynamic parameters KP-stat, KP-dyn (FIG. 3). One advantageous type of combination in further exemplary specific embodiments is, for example, the formation of a sum of selected individual offsets. A static or dynamic parameter in further exemplary specific embodiments thus determines per offset whether this offset is integrated directly into the computation of the address value, i.e., for example, is part of the combination or part of the sum of the offset.

In the simplified representation according to FIG. 11, components 120′, 130′, 140′ according to FIG. 9 are not depicted for the sake of clarity, but merely the data paths corresponding to components 120′, 130′, 140′, data paths associated with an address value ascertainment in FIG. 11 being marked with reference letter a, data paths associated with an input value ascertainment in FIG. 11 being marked with reference letter b, and data paths associated with an evaluation in FIG. 11 being marked with reference letter c.

The configuration unit is also not delineated in FIG. 11—this may be situated in further exemplary specific embodiments, for example, within an offset FB1, . . . , FB5, for example, if it configures the relevant offset, as well as outside the offset, for example, if the configuration is responsible for multiple offsets.

In the present example according to FIG. 11, offsets FB2, FB3, FB4 each have a feedback b, c to itself, for example, in order to recalculate and to overwrite the intrinsic input values. Offset FB2 also sends, for example, a piece of status information c to subsequent offset FB3, which is able to evaluate this piece of status information c. For example, subsequent offset FB3 may in each case advance or update the intrinsic input values by overwriting precisely when offset FB2 has passed completely through one dimension or when offset FB2, for example, from the perspective of FB3, has passed through the inner loop and thus FB3 as the outer loop is able to advance by one iteration, and inner loop FB2 is able to restart. The dimensions or loops passed through by FB2 and FB3 may each be linear or non-linear in further exemplary specific embodiments. The manner of the pass-through of each of the loops of FB2 and the advancement of FB3 may, for example, be similar in each case or different in each case. For example, start value, end value and increment of FB2 may be similar and/or different. For FB3, the increment may be similar or different.

In further exemplary specific embodiments, the offsets may be added up, for example, for generating an address value, cf. block FB5, individual offsets being added up or not being added up in accordance with the configuration unit, for example, as a function of the status of the offsets and/or of the configuration.

In further exemplary specific embodiments, instead of a, for example, dedicated hardware implementation of components 120′, 130′, 140′, functionalities of components 120′, 130′, 140′ in a hardware implementation may also be implemented, for example, also partially or fully overlapping. In further exemplary specific embodiments, for example, an operation used for the re-computation of an input value or a corresponding hardware circuit therefor may also be used in further exemplary specific embodiments for computing the address value to be output.

In further exemplary specific embodiments, device 100, 100a, 100b or an instance of device 100, 100a, 100b may include multiple contexts, for example, in the form of register sets and, for example, may be designed to switch between the multiple contexts or register sets.

Thus, in further exemplary specific embodiments, a physically present arithmetic unit may be used, for example, by two logically independent address value computations, which share, for example, the present physical resources, for example, accordingly by switching the contexts or register sets.

The following exemplary embodiments show further possible forms and configurations according to further exemplary specific embodiments. In this case, the above-described static and/or dynamic configuration parameters are not explicitly listed, but are, however,—if optionally present—apparent from the input values represented by way of example as well as from the implemented computations, comparisons, operations, etc.

FIG. 12 schematically shows a simplified diagram according to further exemplary specific embodiments, in which address values for an access to a two-dimensional array (memory field or data field), for example a 2×3 elements large array, are ascertainable. A first function block FB1, “Offset #0” characterizes a start address or base address of the array, for example 0×1000. A second function block FB2, “Offset #1” facilitates a contribution to the formation of the address value according to a first dimension of the array, and a third function block FB3, “Offset #2” facilitates a contribution to the formation of the address value according to a second dimension of the array. FB1 is not represented for better clarity.

For example, applicable for second function block FB2, “Offset #1” are:

Input values and initial values:
START_SAVE=0
START=0
STOP=2
INCREMENT=1
   (a1): ascertainment of output value of Offset #1 (a1)
=START
   (b1): Ascertainment and overwriting of the input values of Offset #1(b1)
START=START+INCREMENT (c1_finished=false)
START=START_SAVE (c1_finished=true)
   (c1) Evaluation circuit for influencing/controlling Offset #1(c1)
In this exemplary specific embodiment, the computation proceeds, for example, only if the generated address or generated address value AW has been used, otherwise, for example, complete stop of the computations of this offset
c1_finished=START+INCREMENT>=STOP

For example, applicable for third function block FB3, “Offset #2” are:

Input values and initial values:
START=0
STOP=6
INCREMENT=2
   (a2):
=START
   (b2):
START=START+INCREMENT
   (c2): In further exemplary specific embodiments, the computation proceeds, for example, only if c1_finished=true, otherwise, for example, complete stop of the computations of this offset
c2_finished=START+INCREMENT>=STOP

In further exemplary specific embodiments, a combination of the offsets or of the output data of the three function blocks FB1, FB2, FB3 takes place, for example, according to AW=a0+a1+a2 cf. block FB4.
(c)
complete stop of the computations of all offsets, if c2_finished=true

In further exemplary specific embodiments, the input values and computed address AW change based on the configuration according to FIG. 12, for example, as follows:

| Offset#Register | Clock#0 | Clock#1 | Clock#2 | Clock #3 | Clock #4 | Clock #5 |
|---|---|---|---|---|---|---|
| 0#BASE_ADDR | 0x1000 | 0x1000 | 0x1000 | 0x1000 | 0x1000 | 0x1000 |
| 1#START | 0 | 1 | 0 | 1 | 0 | 1 |
| 1#STOP | 2 | 2 | 2 | 2 | 2 | 2 |
| 1#INCREMENT | 1 | 1 | 1 | 1 | 1 | 1 |
| 1#START_SAVE | 0 | 0 | 0 | 0 | 0 | 0 |
| 2#START | 0 | 0 | 2 | 2 | 4 | 4 |
| 2#STOP | 6 | 6 | 6 | 6 | 6 | 6 |
| 2#INCREMENT | 2 | 2 | 2 | 2 | 2 | 2 |
| Computed | 0x1000 | 0x1001 | 0x1002 | 0x1003 | 0x1004 | 0x1005 |
| address | | | | | | |

Further exemplary specific embodiments relate to a generation of addresses or address values of an array of the dimension 2×3 for such an array, which may, for example, be viewed as an alternative to FIG. 12. For example, the configuration depicted by way of example in FIG. 12 may also be used as follows:

Offset #1
Input values and initial values
START=Base address of the array, for example, 0×1000
STOP=Base address of the array, for example, 0×1018 (corresponding to 6 words*4 byte per word=+24 (decimal)=+0×18 (hexadecimal)”)
INCREMENT=4 (32 bit word accesses)
(a1):
=START
(b1):
START=START+INCREMENT
(c1)
The computation proceeds only if the generated address has been used, otherwise complete stop of the computations of this offset
c1_finished=START+INCREMENT>=STOP

Combination of the Offsets:
(a):
=a1
(c)
complete stop of the computations of all offsets, if c1_finished=true

The input values and the computed address change as follows:

| Offset#Register | Clock#0 | Clock#1 | Clock#2 | Clock#3 | Clock#4 | Clock#5 |
|---|---|---|---|---|---|---|
| 1#START | 0x1000 | 0x1004 | 0x1008 | 0x100C | 0x1010 | 0x1014 |
| 1#STOP | 0x1018 | 0x1018 | 0x1018 | 0x1018 | 0x1018 | 0x1018 |
| 1#INCREMENT | 4 | 4 | 4 | 4 | 4 | 4 |
| Computed address | 0x1000 | 0x1004 | 0x1008 | 0x100C | 0x1010 | 0x1014 |

Further exemplary specific embodiments related to a generation of addresses or address values for a triangular matrix.

A triangular matrix in further exemplary specific embodiments, based, for example on the example previously shown with reference to FIG. 12, may be addressed as follows: Offset #0 contains the base address, Offset #1 proceeds column by column through the matrix, Offset #2 proceeds row by row through the matrix, the matrix is, for example, quadratic, for example, 3×3.

If, for example, the upper triangular matrix is to be passed through, it is possible in further exemplary specific embodiments, for example, to not reset the input value “START” after each pass-through of a row to the START_SAVE value, but, for example, to a value that is continuously increased by the value “+1” starting from “0”. This may be achieved, for example, by a second “INCREMENT” value which, in addition to the “START” input value, is also modified.

Offset #1

Input values and initial values
START_SAVE=0
START=0
STOP=3
INCREMENT 1=1
INCREMENT 2=1

(a1):
=START

(b1):
START=START+INCREMENT_1 (c1_finished=false)
START=START_SAVE+INCREMENT_2 (c1_finished=true)
INCREMENT_2=INCREMENT_2+1 (c1_finished=true)

(c1)

In further exemplary specific embodiments, the computation proceeds, for example, only if the generated address or the generated address value has been used, otherwise, for example, a complete stop of the computations of this offset takes place

c1_finished=START+INCREMENT>=STOP

The input values and the computed address change, for example, as follows:

| Offset#Register | Clock#0 | Clock#1 | Clock#2 | Clock#3 | Clock#4 | Clock#5 |
|---|---|---|---|---|---|---|
| 0#BASE_ADDR | 0x1000 | 0x1000 | 0x1000 | 0x1000 | 0x1000 | 0x1000 |
| 1#START | 0 | 1 | 2 | 1 | 2 | 2 |
| 1#STOP | 3 | 3 | 3 | 3 | 3 | 3 |
| 1#INCREMENT_1 | 1 | 1 | 1 | 1 | 1 | 1 |
| 1#INCREMENT_2 | 1 | 1 | 1 | 2 | 2 | 2 |
| 1#START_SAVE | 0 | 0 | 0 | 0 | 0 | 0 |
| 2#START | 0 | 0 | 0 | 3 | 3 | 6 |
| 2#STOP | 9 | 9 | 9 | 9 | 9 | 9 |
| 2#INCREMENT | 3 | 3 | 3 | 3 | 3 | 3 |
| Computed | 0x1000 | 0x1001 | 0x1002 | 0x1004 | 0x1005 | 0x1008 |
| address | | | | | | |

One further alternative for generating addresses or address values of a triangular matrix according to further exemplary specific embodiments is the following:

Offset #1

Input Values and Initial Values
START_SAVE=0
START=0
STOP=3
INCREMENT=1

(a1):
=START

(b1):
START=START+INCREMENT (c1_finished=false)
START=START_SAVE (c1_finished=true)
STOP=STOP−1 (c1_finished=true)

(c1)

In further exemplary specific embodiments, the computation proceeds, for example, only if the generated address or the generated address value has been used, otherwise a complete stop of the computations of this offset takes place

c1_finished=START+INCREMENT>=STOP

Offset #2:

Input Values and Initial Values
START=0
STOP=9
INCREMENT=4

(a2):
=START

(b2):
START=START+INCREMENT

(c2)
The computation proceeds, for example, only if c1_finished=true, otherwise, for example, complete stop of the computations of this offset

c2_finished=START+INCREMENT>=STOP

The input values and the computed address change as follows:

| Offset#Register | Clock#0 | Clock#1 | Clock#2 | Clock#3 | Clock#4 | Clock#5 |
|---|---|---|---|---|---|---|
| 0#BASE_ADDR | 0x1000 | 0x1000 | 0x1000 | 0x1000 | 0x1000 | 0x1000 |
| 1#START | 0 | 1 | 2 | 0 | 1 | 0 |
| 1#STOP | 3 | 3 | 3 | 2 | 2 | 1 |
| 1#INCREMENT | 1 | 1 | 1 | 1 | 1 | 1 |
| 1#START_SAVE | 0 | 0 | 0 | 0 | 0 | 0 |
| 2#START | 0 | 0 | 0 | 4 | 4 | 8 |
| 2#STOP | 9 | 9 | 9 | 9 | 9 | 9 |
| 2#INCREMENT | 4 | 4 | 4 | 4 | 4 | 4 |
| Computed | 0x1000 | 0x1001 | 0x1002 | 0x1004 | 0x1005 | 0x1008 |
| address | | | | | | |

FIG. 13 schematically shows a simplified diagram according to further exemplary specific embodiments, in which, for example, logarithmically increasing address values are ascertainable or generatable by shift operations for an FFT (Fast Fourier Transform).

In an FFT, the data according to further exemplary specific embodiments are read in in a specific manner, represented, for example, by the scheme depicted in FIG. 13, which characterizes a 1024-point FFT including, for example, 10 stages. The first accesses in each case in the first 4 stages ST0, ST1, ST2, ST3 to addresses [l], [l+K] and [T] are represented according to further exemplary specific embodiments. According to further exemplary specific embodiments, [l], [l+K] and [T] are read-accessed, [l] and [l+K] are also write-accessed.

It is apparent that for [l], [l+K] and [T], the number of directly sequential addresses or address values (i.e., increased by +1) increases logarithmically (1, 2, 4, 8, etc.). In order to read in the data of [l], [l+K] and [T] in parallel and to write [l], [l+K] within the scope of the computation of an FFT according to further exemplary specific embodiments, a total of 5, for example, autonomous instances of device 100 according to the specific embodiments are usable. According to further exemplary specific embodiments, identical parts may alternatively also be reused for the computation of the addresses.

According to further exemplary specific embodiments, the offsets for [l] may be analogously formed as follows:

Offset #0
contains constant base address

Offset #1
Start value for each pass-through=0
Increment value for continuous increase of the addresses=1
initial stop value=1 after each pass-through of the offset (reaching the stop value) overwrite by: stop value=stop value

SHL 1 (shift left by 1)

for the formed addresses or address values for stage #0 ST0, this results in:

0->0->0, etc.

for the formed addresses or address values for stage #1 ST1, this results in:

0, 1->0, 1->0, 1 etc.

for the formed addresses or address values for stage #2 ST2, this results in:

0, 1, 2, 3->0, 1, 2, 3->0, 1, 2, 3, etc.

Offset #2
Start value=0
initial increment value=2, after each pass-through of the offset (reaching the stop value) overwrite by: increment value=increment value SHL 1 (shift left by 1)
Stop value=1024

for the formed addresses or address values for stage #0 ST0, this results in:

0, 2, 4, . . . , 1022

for the formed addresses or address values for stage #1 ST1, this results in:

0, 4, 8, 12, . . . , 1020

for the formed addresses or address values for stage #2 ST2, this results in:

0, 8, 16, 32, . . . , 1016

Offset #3
Start value=0
Stop value=10, corresponding to the number of stages of the FFT (0 through 9, i.e., 10)

For example, the formed addresses or address values for the stages are not incorporated in this case into the address computation, but serve merely, for example, as loop counters.

In further exemplary specific embodiments, the offsets for [l+K] may be analogously based on [l], see above, for example, with the difference, however, that the start value of Offset #2 starts with 1 and is shifted to the left by 1 bit in each case.

In further exemplary specific embodiments, the offsets for [T] may be analogously based on [l], see above, including the following exemplary adaptations.

Offset #0
contains base address

Offset #1
Start value for each pass-through=0
initial increment value=512, after each pass-through of the offset (reaching the stop value), overwrite by: increment value=increment value SRL 1 (shift right by 1)
Stop value=512

for the formed addresses or address values for stage #0, this results in: 0->0->0, etc.

for the formed addresses or address values for stage #1, this results in: 0, 256->0, 256->0, 256, etc.

for the formed addresses or address values for stage #2, this results in: 0, 128, 256, 384->0, 128, 256, 384->0, 128, 256, 384, etc.

Offset #2
Start value for each pass-through=0
Initial increment value=1, after each pass-through of the offset (reaching the stop value) overwrite by: increment value=increment value SHL 1

(shift left by 1)
Stop value=512

for the formed addresses or address values for stage #0, this results in: 0, 1, 2, 3, . . . , 511->0, 1, 2, 3, . . . , 511-> etc.

for the formed addresses or address values for stage #1, this results in: 0, 2, 4, 6, . . . , 510->0, 2, 4, 6, . . . , 510-> etc.

for the formed addresses or address values for stage #2, this results in: 0, 4, 8, 12, . . . , 508->0, 4, 8, 12, . . . , 508->, etc.

Important: the formed addresses for the stages in this case are not incorporated into the address computation, but serve merely as loop counters.

Offset #3
Start value=0
Stop value=10, corresponding to the number of stages of the FFT (0 through 9, i.e., 10).

In further exemplary specific embodiments, the formed addresses or address values for the stages are not incorporated into the address computation, but serve, for example, merely as loop counters.

In the above-mentioned examples, left and right shift operations by the fixed value of 1 are used, for example. In further exemplary specific embodiments, for example, constant shifts deviating from 1 are also possible, in further exemplary specific embodiments, shift operations by a variable value are equally possible. In this case, one of the input values, for example, forms the value to be shifted and a second of the input values forms the value by which the shift takes place.

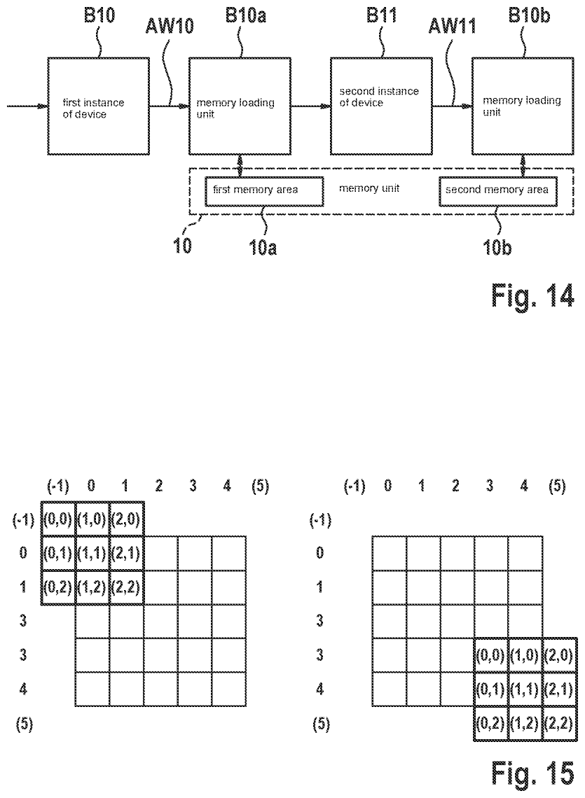

FIG. 14 schematically shows a simplified block diagram according to further exemplary specific embodiments. One example of a coupling of two instances of device 100 according to the specific embodiments is depicted for generating, for example, optional/direct addresses or address values, for example, for an access to a not fully occupied matrix (sparse matrix).

One first instance of device 100 is identified in FIG. 14 with reference numeral B10, one second instance of device 100 is identified in FIG. 14 with reference numeral B11. Reference numerals B10a, B11a symbolize a respective memory loading unit, which uses address values AW10, AW11 formed with the aid of blocks B10, B11. First instance B10 in this case generates, for example, addresses or address values AW10, which describes a relative position of data, which contains, for example, the optional addresses—for example, to be loaded from the memory. These addresses AW10 are conveyed to first loading unit B10a, which then reads in the data from the memory including the optional addresses (for example, from a memory unit 10). First loading unit B10a now writes, for example, the read-in optional addresses as input values into second instance B11 which, in turn, computes, for example, from the incoming optional addresses together with an internal computation, a final address or a final address value AW11. The use of two loading units B10a, B11a, which are able to access separate memory areas independently of one another, is advantageous, for example: for example, a first memory area 10a, which contains the optional—to be loaded—addresses, and a second memory area 10b to which the optional addresses may be applied. The two memory areas 10a, 10b may be located, for example, within the same physical memory or in physical memories separated from one another.

In further exemplary specific embodiments, the offsets for reading in the optional addresses may, for example, be configured as follows (B10).

Offset #0
contains base address of the optional addresses to be read in

Offset #1
Start value=0
Increment value=1
Stop value=number of optional addresses to be read in optionally, Offset #2

For example, for reading in multiple areas including optional addresses, where the computed address would be added on to Offset #1.

For example, for repeatedly reading in the same area including optional addresses, where the computed address would not be added on to Offset #1.

For example, the offsets for the generation of the address values for the data including the optional addresses may be configured as follows (B11)

Offset #0
contains base address of the memory area to which the optional addresses are applied.

Offset #1
Start value=0
Increment value=for example, input value written from the outside, is invalidated, for example, after each use/after each address generation, data are accepted from the outside, for example, only if the increment value is invalid.
Stop value=number of optional addresses to be read in.

If the number of optional addresses to be read in is unknown, an increment value written from the outside, for example which, added to the start value, exceeds the stop value, may result in an abort of the computation. Alternatively, a further input value received from the outside, for example, a loop-level, could indicate the last element of a series of optional addresses.

Optionally, Offset #2

For example, for reading in multiple memory areas to which the optional addresses are applied, where the computed address would be added on to Offset #1.

For example, for reading in the same memory area to which the optional addresses are applied, where the computed address would not be added on to Offset #1.

In further exemplary specific embodiments, a, for example, hierarchical coupling of multiple instances of the device according to the specific embodiments is also usable for generating individual addresses per loading/memory unit B10a, B11a, for example, while avoiding redundant partial computations.

One example for carrying out a wrap at a memory boundary according to further exemplary specific embodiments is specified below: by evaluating input values, it may be checked whether addresses or address values are within a particular range or value range. If the addresses are outside the range, then it is possible in further exemplary specific embodiments to carry out a subtraction of this range, for example, by the relevant address value, for example. In this way, the behavior of a wrap, for example, may be implemented in further exemplary specific embodiments:

Offset #0
contains base address of the memory area

Offset #1
Start value=5
Increment value=1
Stop value=8, is decremented in each case by 1
Wrap value=8

The input values and the computed address change in further exemplary specific embodiments as follows:

| Offset#Register | Clock#0 | Clock#1 | Clock#2 | Clock#3 | Clock#4 | Clock#5 | Clock#6 | Clock#7 |
|---|---|---|---|---|---|---|---|---|
| 0#BASE_ADDR | 0x1000 | 0x1000 | 0x1000 | 0x1000 | 0x1000 | 0x1000 | 0x1000 | 0x1000 |
| 1#START | 5 | 6 | 7 | 0 | 1 | 2 | 3 | 4 |
| 1#INCREMENT | 1 | 1 | 1 | 1 | 1 | 1 | 1 | 1 |
| 1#STOP | 8 | 7 | 6 | 5 | 4 | 3 | 2 | 1 |
| 1#IWRAP | 8 | 8 | 8 | 8 | 8 | 8 | 8 | 8 |
| Computed | 0x1005 | 0x1006 | 0x1007 | 0x1000 | 0x1001 | 0x1002 | 0x1003 | 0x1004 |
| address | | | | | | | | |

FIG. 15 schematically shows a simplified diagram according to further exemplary specific embodiments. Specific edge treatments, for example, may be used when filtering data, for example, when filtering a video image with the aid of an edge filter. This is the case, for example, if the size of the target image is to correspond to the size of the input image, since the filter “protrudes” beyond the edge of the image. In this case, the pixels of the input image situated outside the actual input image, for example, are classified as “0”, i.e., a padding with “0” is carried out. In further exemplary specific embodiments, the relevant value is not padded as “0”, i.e., written, but, for example, only assumed as such. If, for example, the lines of an image are situated directly adjacently to one another, the writing of a “0” outside a line would effectively even mean the generally impermissible overwriting of a pixel of the preceding or following line.

In further exemplary specific embodiments, it may be advantageous to check the address generation or address value generation, for example, as to whether the respective pixel is situated outside the actual image. In this case, for example, a completely different address could be generated in further exemplary specific embodiments which, for example, points to a memory location, in which the value is “0”.

In a presently considered “Example A”, an image of the size 5×5 is filed with a 3×3 filter, for example, see FIG. 15. The filter filters, for example, currently the line “0”, point “0”, see the left-hand image from FIG. 15. The input values of the image for filtering with filter coordinates (0,0),(1,0),(2,0),(0,1),(0,2) are not available, since the corresponding pixels (−1,−1),(0,−1),(1,−1),(−1,0),(−1,1) are situated outside the image. Device 100 according to the specific embodiments could, for example, have a, for example, internal input value that has the value “−1”. Using an internal check according to further exemplary specific embodiments, it could be established, for example, by an evaluation with respect to the value “0” that “−1” is smaller than “0”. Using a corresponding configuration, it would be possible according to further exemplary specific embodiments—instead of using the value “−1”, to use a completely different input value, for example, an input value, which contains the value “25”, which is situated, for example, outside the image data (with the address values 0 through 24 corresponding to the size 5×5) and contains the data value “0”—for example, the value usable for the padding. The check according to further exemplary specific embodiments could, for example, be applied with respect to the line index and/or the index of a point within a line.

One further possible “Example B” according to further exemplary specific embodiments is based on the above-described “Example A”. The input values of the image for filtering with filter coordinates (0,2),(1,2),(2,2),(2,0),(2,1) are not available, since the corresponding pixels (3,5),(4,5),(5,5),(5,3),(5,4) are situated outside the image, cf. the right-hand image of FIG. 15. According to further exemplary specific embodiments, a further internal check of lines and pixel index could be carried out here—specifically, with respect to the value “5”. By using a corresponding configuration, it would be possible according to further exemplary specific embodiments, similar to the aforementioned—instead of outputting the value “5”—to output, for example, also the address “25”, which is situated outside the values of the 5×5 image and, in particular, may contain the value “0” for the padding.

Alternatively, instead of continuously accessing address “25” with each padding, an entire additional line with the index “5” could according to further exemplary specific embodiments also exist (outside the lines 0 through 4 of the 5×5 image), which are padded with padding values. In this way, no line overrun needs to be checked. In addition, however, the memory accesses further to be carried out according to further exemplary specific embodiments for the padding of the pixels within a line, i.e., the columns situated outside a line due to the padding, could be distributed to the various pixels of line “5”, in order to prevent multiple accesses always to the same memory bank which, according to further exemplary specific embodiments, would otherwise possibly result in a greater decline in performance than a distribution of the padding accesses to multiple banks.

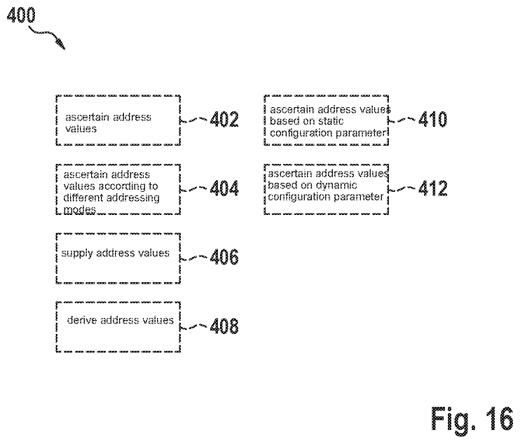

Further exemplary specific embodiments, FIG. 16, relate to a use 400 of the device according to the specific embodiments and/or of the unit for loading and/or storing data according to the specific embodiments and/or of the system according to the specific embodiments and/or of the processing unit according to the specific embodiments and/or of the method according to the specific embodiments for at least one of the following elements: a) ascertainment 402 of address values, for example, for an access to a memory unit, b) ascertainment 404 of address values according to different, for example complex, addressing modes, c) supplying 406 a unit for loading and/or storing data and/or a processing unit with address values for accesses to a memory unit, d) deriving 408 address values based on other address values and/or configuration data, e) ascertaining 410 address values based on at least one static configuration parameter, f) ascertaining 412 address values based on at least one dynamic configuration parameter.

The principle according to the specific embodiments may be used in further exemplary specific embodiments, for example, for efficiently ascertaining address values for memory accesses (for example, reading and/or writing), for example, for hardware accelerators and/or for a hardware for evaluating a data flow (“data flow processor”). In further exemplary specific embodiments, a provision and/or storing of data or the generation of corresponding address values AW for the provision and/or storing of the data for an algorithm to be computed may take place equally fast as, for example, a computation of the algorithm (in terms of the throughput). In other words, as a result of the principle according to the specific embodiments, address values for memory accesses are so quickly ascertainable or providable that algorithms—even on, for example, specific accelerator hardware—are efficiently implementable, in particular, for example, without the evaluation of the algorithms having to be at least temporarily suspended or slowed because, for example, of having to wait for a formation of address values for steps of the algorithm to be evaluated in the future. In other words, exemplary specific embodiments for an execution of algorithms are able to ascertain or provide (for example, to a unit 5 for loading/storing data) useable address values so quickly that a unit executing the algorithm does not have to wait for the address values (“real time” or “relative real time”).

The principle according to the specific embodiments may be used in further exemplary specific embodiments to provide a hardware circuit (for example, having the functionality of device 100, 100a, 100b, 100c) for address generation or address value generation, which ascertains, for example, autonomously, for example, in each clock of a clock signal, a new address or a new address value AW, for example, also with respect to addresses for complex access patterns.

Further exemplary specific embodiments may make it possible for the address generation to be able to take place, for example, equally as quickly or in parallel to the use of the addresses. In this way, the addresses or address values may be generated, for example, in parallel to the execution of the algorithm.

Further exemplary specific embodiments facilitate a, for example, native support of complex address access patterns which, for example, from an algorithmic perspective, facilitates a high-performance provision of data in a sequence, for example, in order to execute complex algorithms without additional waiting times (for example, for address values or memory accesses based thereon). In this way, downstream processing units, for example, may be optimally supplied in further exemplary specific embodiments with data or upstream processing units are able to optimally store data.

For example, it is possible as a result of the principle according to the specific embodiments to forego, at least temporarily, conventional methods, in particular, a time-consuming computation of the addresses and/or a previous restructuring or manipulation of the data, which are accompanied in each case by additional run time and additional power requirements.

The address generation or address value generation according to the specific embodiments may be used, for example, in combination with at least one loading unit or memory unit 5 (FIG. 4), the generated addresses being capable of being used directly or indirectly as memory addresses, for example, in the loading unit or memory unit. In this way, new data may typically be requested or written in loading unit or memory unit 5, for example, in each clock.

One further advantageous use of the principle according to the specific embodiments is a generation of data values AW, which are not used in terms of an address, but as actual data. These generated data values AW may, for example, be used directly for subsequent computations.

The device according to the specific embodiments is scalable, for example, with respect to the complex access patterns to be supported as well as, for example, with respect to area or area use and/or performance and/or power. The actual implementation for a specific target system (for example, microcontroller 300) may thus be optimally adapted in further exemplary specific embodiments for an actual intended application.

1-21. (canceled)

22. A device for ascertaining address values for an access to a memory unit, the device comprising:
an input value memory configured to store at least temporarily at least two input values;
wherein the device is configured to ascertain at least temporarily at least one address value based on the at least two input values.

23. The device as recited in claim 22, further comprising:
at least one input interface configured to receive at least one first input value or the at least two input values, from a further external unit.

24. The device as recited in claim 22, further comprising:
at least one output interface configured to output the at least one address value.

25. The device as recited in claim 22, further comprising:
at least one address value ascertainment unit configured to ascertain the address value.

26. The device as recited claim 22, wherein the device is configured to ascertain at least temporarily at least one new input value, based on at least one first input value of the at least two input values or based on the at least two input values, and to overwrite at least one of the input values stored in the input value memory with the new input value.

27. The device as recited in claim 22, further comprising:
at least one input value ascertainment unit configured to ascertain at least temporarily at least one new input value, based on at least one first input value of the at least two input values or based on the at least two input values.

28. The device as recited in claim 22, wherein the device configured to evaluate at least temporarily a) at least one first input value of the at least two input values orb) the at least two input values, an evaluation result being obtained, and the device is configured to influence at least temporarily, based on the evaluation result, at least one of the following elements: a) the ascertaining of the at least one address value, b) the at least one address value, c) an address value ascertainment unit, d) an ascertaining of a new input value, d) an overwriting of the at least one input value stored in the input value memory with the new input value.

29. The device as recited in claim 22, further comprising:
at least one evaluation unit, which is configured to evaluate at least temporarily a) at least one first input value of the at least two input values, orb) the at least two input values, an evaluation result being obtained, and the evaluation unit is configured to influence at least temporarily, based on the evaluation result, at least one of the following elements: a) the ascertaining of the at least one address value, b) the at least one address value, c) an address value ascertainment unit, d) an ascertaining of a new input value, e) an overwriting of the at least one input value stored in the input value memory with the new input value.

30. The device as recited in claim 22, further comprising:
at least one configuration unit, which is configured to influence or to change at least temporarily a configuration of at least one of the following elements: a) the device, b) the input value memory, c) an address value ascertainment unit, d) an input value ascertainment unit, e) an evaluation unit, f) an input interface, g) an output interface, the influencing or changing being carried out at least temporarily based on at least one static configuration parameter and/or based on at least one dynamic configuration parameter.

31. The device as recited in claim 22, wherein the device is configured to ascertain at least temporarily address values according to one first, for example, complex addressing mode and to ascertain at least temporarily address values according to one second complex addressing mode, the device configured to ascertain and/or generate and/or combine a plurality of linearly or non-linearly changing address values.

32. The device as recited in claim 22, further comprising:
at least one component configured to carry out at least temporarily at least one of the following operations: a) addition, b) subtraction, c) arithmetic and/or logical shifting, d) multiplication, e) use or evaluation of at least one lookup table including a conversion table, f) butterfly, g) inverse increment, h) comparisons with respect to zero, greater than zero and/or smaller than zero and/or greater than or equal to zero and/or smaller than or equal to zero, and/or comparisons with respect to values not equal to zero, i) at least one combination from the above-listed operations a), b), c), d), e), f), g), h), variables and/or constants being useable as input values for at least some of the operations a), b), c), d), e), f), g), h), i).

33. The device as recited in claim 22, wherein the device is configured to invalidate and/or declare as invalid and/or to treat as invalid, at least temporarily at least one input value of the at least two input values, to stop at least temporarily an operation of at least one component of the device, and, to continue the operation of the at least one stopped component of the device.

34. The device as recited in claim 22, wherein the device is configured to block at least temporarily a writing of data into the input value memory and/or a writing or overwriting of input values and/or to stop at least temporarily an operation of at least one component of the device.

35. The device as recited in claim 22, wherein the device is configured completely as a hardware circuit.

36. A unit for loading and/or storing data, comprising:
at least one device for ascertaining address values, including:
an input value memory configured to store at least temporarily at least two input values,
wherein the device is configured to ascertain at least temporarily at least one address value based on the at least two input values;
wherein the unit is configured to utilize the device for ascertaining at least one address value for a write access and/or for a read access to a memory unit.

37. A system for ascertaining address values for an access to a memory unit, the system comprising:
at least two devices, each of the at least two device including:
an input value memory configured to store at least temporarily at least two input values,
wherein each of the two devices is configured to ascertain at least temporarily at least one address value based on the at least two input values.

38. A microcontroller, comprising:
at least one device for ascertaining address values, including:
an input value memory configured to store at least temporarily at least two input values,
wherein the two device is configured to ascertain at least temporarily at least one address value based on the at least two input values.

39. A method for ascertaining address values for an access to a memory unit, comprising:
storing at least temporarily at least two input values in an input value memory; and
ascertaining at least temporarily at least one address value based on the at least two input values.

40. The method as recited in claim 39, further comprising:
ascertaining a new input value based on at least one first input value of the at least two input values or based on the at least two input values; and
overwriting at least one of the input values stored in the input value memory with the new input value.

41. The method as recited in claim 40, further comprising:
evaluating at least temporarily a) at least one first input value of the at least two input values or b) the at least two input values, an evaluation result being obtained;
influencing at least temporarily, based on the evaluation result, at least one of the following elements: a) the ascertaining of the at least one address value, b) the at least one address value, c) an address value ascertainment unit, d) the ascertaining of a new input value, e) the overwriting of the at least one input value stored in the input value memory with the new input value.

42. The device as recited in claim 22, wherein the device is used for at least one of the following elements: a) ascertainment of address values for an access to a memory unit, b) ascertainment of address values according to different complex addressing modes in time multiplex, c) supplying a unit for loading and/or storing data and/or a processing unit with address values for accesses to a memory unit, d) deriving address values based on other address values and/or configuration data, e) ascertaining address values based on at least one static configuration parameter, f) ascertaining address values based on at least one dynamic configuration parameter.
